(19) United States
(12) Patent Application Publication
(10) Pub. No.: US 2006/0167388 A1
(43) Pub. Date: Jul. 27, 2006

(54) Foot sole massager

(76) Inventor: Shih-Huang Chen, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/041,741

(22) Filed: Jan. 25, 2005

(51) Int. Cl. A61H 15/02

(52) U.S. Cl. 601/15; 601/22; 601/19

(57) ABSTRACT

A foot sole massager includes a housing, a massager mechanism, far infrared devices, and a temperature controlled device; the housing has juxtaposed openings on an uppermost portion; the massager mechanism is positioned in the opening; the far infrared devices are positioned in the housing so as to face respective ones of the openings; the far infrared devices have elongate far infrared heaters perpendicular to a front side of the housing such that a user's feet will be parallel to the elongate far infrared heaters while the massager mechanism is being used; the temperature controlled device is positioned in the housing for detecting ambient temperature produced by the far infrared devices as well as limiting the temperature within a predetermined range; the temperature controlled device can stop power from being supplied to the far infrared devices as soon as the temperature increases to be higher than a maximum allowed value, thus preventing the massager mechanism from getting too hot.

### BACKGROUND OF THE INVENTION

1. Field of the Invention

The present invention relates to a foot sole massager, more particularly one, which is structured in such a way that heat produced by far infrared devices thereof can spread uniformly on the user's soles, and which is equipped with a temperature controlled device for limiting the ambient temperature produced by the far infrared devices within a predetermined range.

2. Brief Description of the Prior Art

Massage is one of the easiest ways of attaining and maintaining good health and well-being. According to medical researches, headaches, aches and pains, tension, and stress can all be alleviated by means of massaging the soles.

Therefore, various types of sole massagers are developed for allowing people to massage their soles without using the hands, e.g. those with rollers, those with vibratory elements, and those with up and down movable posts.

However, such conventional sole massagers, whose function is limited to sole massaging, can't any longer interest the consumers because single-function products are considered to be less worth buying as compared with versatile ones.

### SUMMARY OF THE INVENTION

It is a main object of the invention to provide an improvement on a foot sole massager, which has a far infrared warming mechanism besides the massaging elements, to overcome the above disadvantages.

The foot sole massager of the present invention includes a housing, a massager mechanism, far infrared devices, and temperature controlled device. The housing has openings on an uppermost portion, and the massager mechanism is positioned in the opening. The far infrared devices are positioned in the housing so as to face respective ones of the openings, and they have elongate far infrared heaters perpendicular to a front side of the housing such that the user's feet will be parallel to the elongate far infrared heaters while the massager mechanism is being used. The temperature controlled device is used for detecting the temperature produced by the far infrared devices as well as limiting the temperature within a predetermined range; the temperature controlled device can stop power from being supplied to the far infrared devices as soon as temperature increases to be higher than a maximum allowed value.

### BRIEF DESCRIPTION OF THE DRAWINGS

The present invention will be better understood by referring to the accompanying drawings, wherein:

FIG. 1 is a perspective view of the foot sole massager according to the present invention,

FIG. 2 is an exploded perspective view of the foot sole massager according to the present invention,

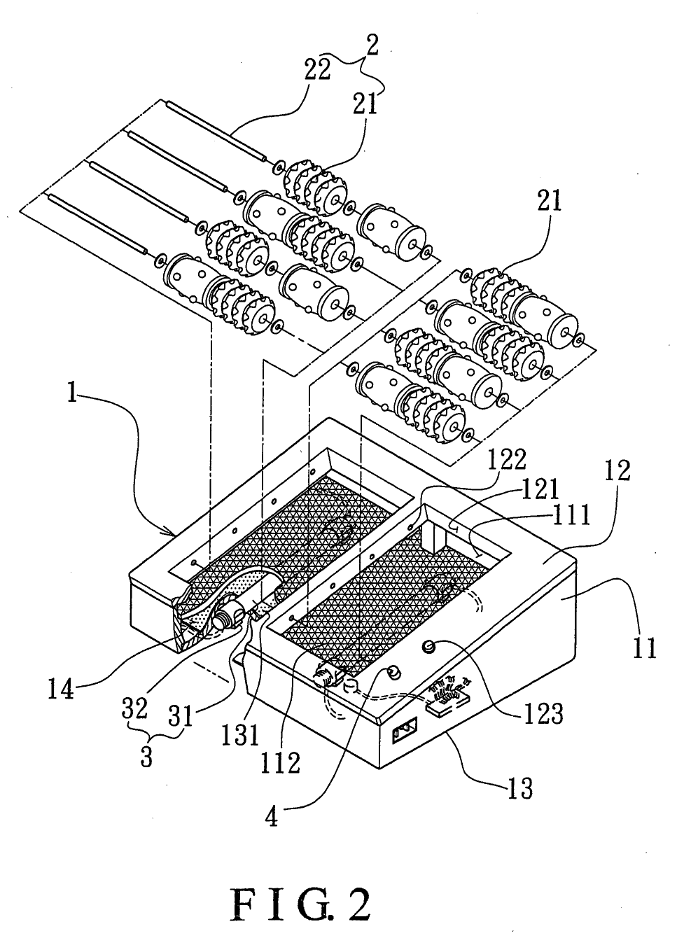

FIG. 3 is a side view of the present foot sole massager, and

FIG. 4 is a front view of the present foot sole massager.

### DETAILED DESCRIPTION OF THE PREFERRED EMBODIMENTS

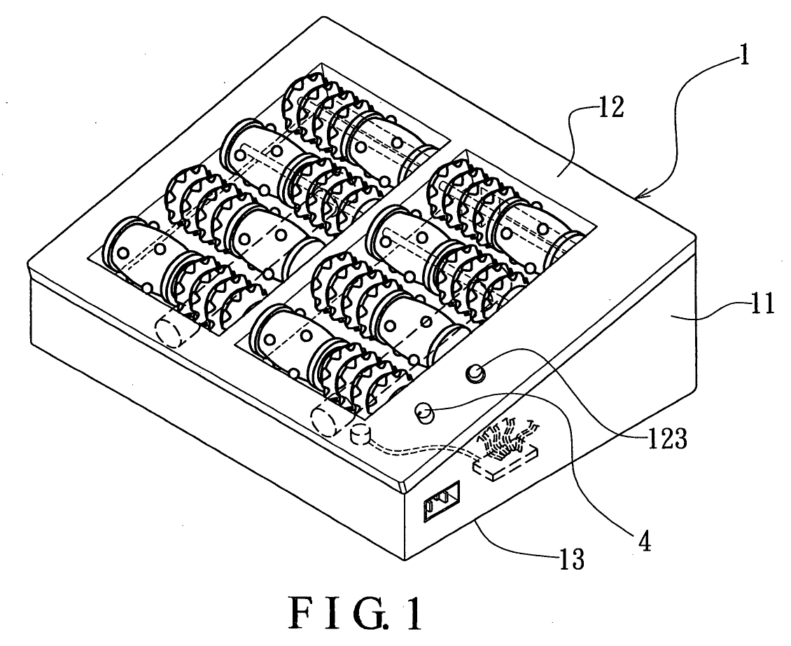

Referring to FIG. 1, a preferred embodiment of a foot sole massager includes a housing 1, a sole massager mechanism 2, two far infrared devices 3, and a temperature controlled device 4.

The housing 1 includes four lateral portions 11, an uppermost portion 12, a bottom 13, and a holding space 14 therein. The uppermost portion 12 has two juxtaposed openings 121, and several pairs of opposing holes 122, which face the openings 121. Each of the four lateral portions 11 has a step-shaped portion 111 on an inner side while a net 112 is supported on the step-shaped portions 111, apart from both the uppermost portion 12 and the bottom 13. Furthermore, a power switch 123 is arranged on the uppermost portion 12, and a reflecting plate 131 is stuck on an upper side of the bottom 13.

The sole massager mechanism 2 includes several massaging bodies 21, and pivotal shafts 22, which are passed through respective ones of the massaging bodies 21, and passed into the holes 122 of the uppermost portion 12 of the housing 1 at two ends; thus, the massaging bodies 21 are spaced apart, and they will turn around the pivotal shafts 22 when one slides his feet to and fro on the massager mechanism 123 to massage his feet; the massaging bodies 21 include those that have a corrugated shape and have cavities thereon, and those that have a tube shape and have bumps thereon, and they can be made of woods such that they can produce phytonicidene.

Each of the far infrared devices 3 includes an elongate far infrared heater 31, and two seats 32, which are connected to respective ones of two ends of the far infrared heater 31; the far infrared devices 3 are positioned on the reflecting plate 131 with the seats 32 secured to the housing 1, and with the elongate far infrared heaters 31 being positioned such that they are perpendicular to the front portion of the housing 1, and face respective ones of the openings 121 of the housing 1, and such that the user's feet will be parallel to the far infrared heaters 31 when sliding forwards and backwards on the sole massager mechanism 2 to massage the soles with the massaging bodies 21.

The temperature controlled device 4 is positioned in the housing 1 for detecting the ambient temperature produced by the far infrared devices 3 as well as limiting the ambient temperature within a predetermined range; thus, the massaging bodies 21 are prevented from getting too hot; the temperature controlled device 4 will stop power from being supplied to the far infrared devices 3 as soon as the temperature increases to be higher than 85° C., and it will make the far infrared devices 3 powered again as soon as the temperature reduces to be lower than 55° C.

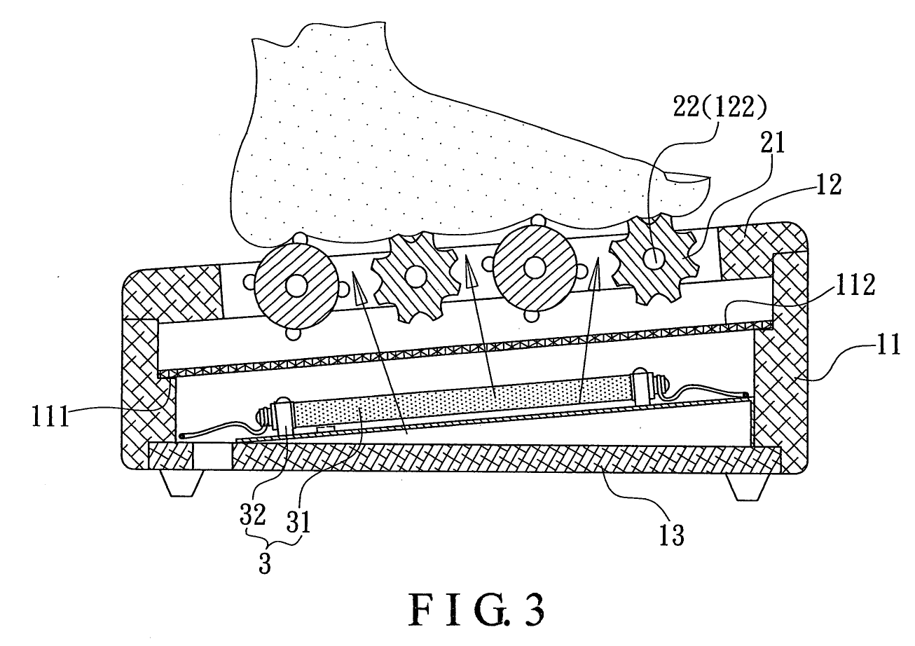

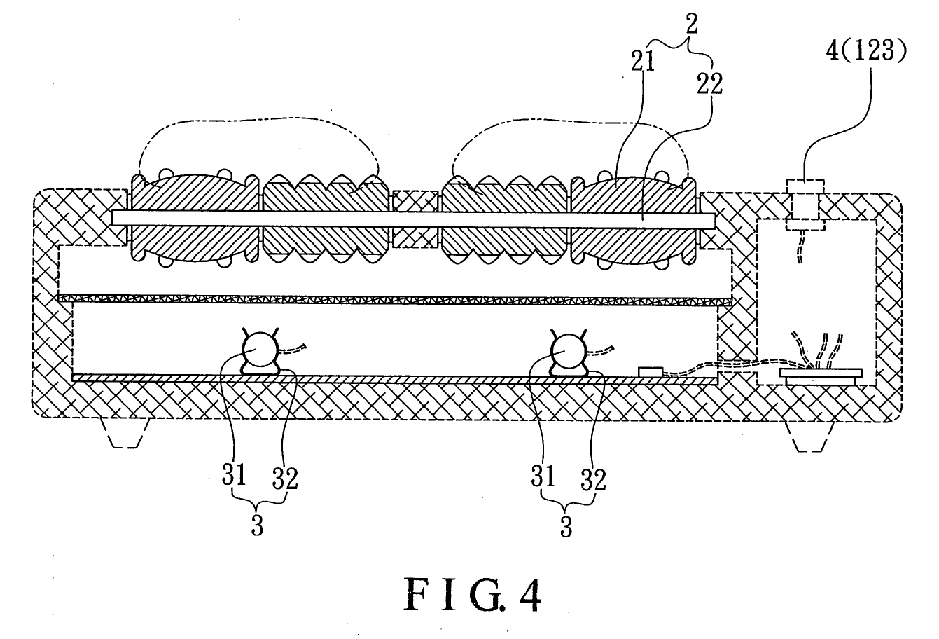

Referring to FIGS. 3 and 4, because the far infrared heaters 31 are perpendicular to the front portion of the housing 1, heat produced by the far infrared heaters 31 will travel through the spaces between the massaging bodies 21 as well as the spaces between the uppermost portion 11 of the housing 1 and the massager mechanism 2 after the far infrared devices 3 are activated. Therefore, heat from the far infrared heaters 31 will spread uniformly on the user's soles while the feet are being forwards and backwards slid on the massager mechanism 2.

From the above description, it can be easily understood that the foot sole massager of the present invention has advantages as followings:

1. Because the elongate far infrared heaters are perpendicular to the front portion of the housing, heat produced by the elongate far infrared heaters can spread uniformly on the user's soles while the feet are being forwards and backwards slid on the massager mechanism.

2. The foot sole massager has the temperature controlled device to prevent the far infrared devices from producing too much heat therefore the risk of the user's soles being burned is eliminated.

What is claimed is:

1. A foot sole massager, comprising
a housing having a holding space therein; the housing having a plurality of juxtaposed openings on an uppermost portion thereof;
a sole massager mechanism positioned within the opening of the housing;
a plurality of far infrared devices positioned in the holding space of the housing; the far infrared devices facing respective ones of the openings of the housing; the far infrared devices having elongate far infrared heaters substantially perpendicular to a front side of the housing; and
a temperature controlled device positioned in the housing for detecting ambient temperature produced by the far infrared devices as well as limiting the ambient temperature within a predetermined range; the temperature controlled device being capable of stopping power from being supplied to the far infrared devices as soon as temperature increases to be higher than a maximum allowed value;
whereby a user's feet will be parallel to the far infrared heaters, and heat produced by the far infrared devices will spread uniformly on soles of the user while the massager mechanism is being used to massage the soles.
